(19) United States
(12) Patent Application Publication
(10) Pub. No.: US 2026/0158425 A1
(43) Pub. Date: Jun. 11, 2026

(54) FILTER ELEMENT AND FILTER WITH POSITIONING FEATURE

(71) Applicant: ZHEJIANG LAIEN FILTRATION SYSTEM CO., LTD., Huzhou City (CN)

(72) Inventors: QING-LIN DENG, Huzhou City (CN); JIAN-BIN CHENG, Huzhou City (CN); YU ZHANG, Huzhou City (CN); XIAO-WEI YING, Huzhou City (CN)

(21) Appl. No.: 19/178,924

(22) Filed: Apr. 15, 2025

(30) Foreign Application Priority Data
Apr. 19, 2024 (CN) 202420814768.1

(51) Int. Cl. B01D 35/30; B01D 35/153

(52) U.S. Cl. CPC B01D 35/30; B01D 35/153; B01D 2201/291; B01D 2201/4046

(57) ABSTRACT

The invention discloses a filter element with a positioning characteristic and a filter, wherein the filter element comprises an annular filter medium, a first end cover and a second end cover, the first end cover and the second end cover are connected to the two ends of the annular filter medium, and the annular filter medium is provided with a central cavity which is arranged around the central axis of the central cavity; and an oil return plug is eccentrically arranged on the end face of the first end cover, and is provided with an outward-extending positioning contour which is matched with an internal component of a filter assembly, used to positioning the internal components of the filter assembly, so that when the filter element is installed into the filter assembly, the oil return plug enters and closes the return channel.

### TECHNICAL FIELD

The invention belongs to the technical field of filters, and particularly relates to a filter element with positioning characteristics and a filter.

### BACKGROUND

During the maintenance and replacement of the filter element of the filter, in order to avoid environmental pollution caused by oil overflow, an oil return channel is set in the filter assembly. The filter element is provided with an oil return plug and a guide piece (positioning piece). When the filter element is installed correctly, the guide piece (positioning piece) enables the oil return plug of the filter element to seal the oil return channel to ensure normal system oil pressure. During the disassembly of the filer element, the oil return channel needs to be opened to discharge the oil in the filter assembly.

Generally, during the installation of the filter, the operator must accurately adjust the rotation position between the guide and the oil return plug when installing the annular filter element into the filter housing, which is prone to errors based on experience. In addition, due to the different structures of the filter element and the matched filter assembly in practical application, it is necessary to strictly control the position of these parts during rotation to complete the assembly of the filter element and ensure that its position does not deviate.

U.S. Pat. No. 11,305,219 B2, for example, discloses a filter system comprising a filter housing with a housing pot and a housing cover which can be screwed onto or into the housing pot with a screwing movement, the housing pot having an outflow channel with a bottom-side outflow opening, a filter element having on its lower end disc a closing element which is arranged eccentrically with respect to the longitudinal axis of the filter element and extends sealingly past or to the bottom-side outflow opening in a predetermined installation position of the filter element.

Therefore, due to the precision setting of the rotating position, the processing process of the filter element becomes complex and difficult to control, and the processing position deviation is easy to occur, which leads to the misinstallation of the product, and then the product is scrapped, and the cost of the product is also high.

### SUMMARY OF THE INVENTION

The main purpose of the invention is to provide a filter element and a filter with positioning characteristics, aiming at solving the technical problems of difficult operation and complex processing of the filter element with a guide element in the use process.

In order to achieve the above object, the filter element with positioning features proposed by the present invention comprises:
An annular filter medium having a central cavity defined about a central axis thereof;
A first end cover and a second end cover connected to both ends of the annular filter media;
Wherein the end face of the first end cover is eccentrically provided with an oil return plug and is provided with a positioning contour extending outwards for coordination with an internal component of the filter assembly, so that the oil return plug enters and closes an oil return channel when the filter element is installed in the filter assembly;
The positioning contour comprises at least one bent section so as to be positioned in the filter assembly, and the bent section of one of the walls is provided with an orientation portion for positioning engagement with a guide portion in the filter assembly.

Optionally, the positioning contour is a wall extending axially outward from an end face of the first end cover.

Optionally, the outer edge of the wall extending axially outward along the end face of the first end cover includes at least one high point and at least one low point with a smooth transition between the high point and the low point of the outer edge.

Optionally, the wall is provided continuously or discontinuously along the circumference of the first end cover.

Optionally, the wall is continuously arranged along the circumference of the first end cover (2), and the inner circumferential surface of the annular wall is matched with the outer circumferential surface of the inner member of the filter assembly.

Optionally, the oil return plug is located on the outside of the continuous wall.

Optionally, the center of the first end cover is provided with an opening into the central cavity, and the positioning contour is disposed around the opening.

Optionally, a ring is formed extending outward along the opening, and a reinforcing rib is connected between the positioning contour and the ring.

The invention also provides a filter comprising:
The filter element with the positioning feature;
A filter assembly having a coordination contour that mates with the positioning contour.

Optionally, the filter assembly is provided with a central tube communicating with the central cavity, and the coordination contour is formed in the central tube.

In the technical scheme of the invention, the first end cover connected to one end of the annular filtering medium is provided with the positioning contour extending outwards, so that an operator can visually align and then guide by the positioning contour until the filter element is positioned in the filter assembly, meanwhile, the bending section limits the rotating position of the filter element, and the orientation part prevents the filter element from being reversely installed by 180 degrees, so that an oil return channel in the shell is accurately sealed by an oil return plug on the first end cover.

### BRIEF DESCRIPTION OF THE DRAWINGS

In order to more clearly illustrate the embodiments of the present invention or the technical solutions in the prior art, the following will briefly introduce the drawings used in the description of the embodiments or the prior art. Obviously, the drawings in the following description are only some embodiments of the present invention. For those skilled in the art, other drawings can be obtained according to the structure shown in these drawings without creative work.

FIG. 1 is a perspective view of an embodiment of a filter element with a positioning feature according to the present invention;

FIG. 2 is a side view of FIG. 1;

FIG. 3 is an exploded view of an embodiment of a filter according to the present invention;

FIG. 4 is a perspective view of the filter assembly of FIG. 3;

FIG. 5 is a top view of the filter assembly of FIG. 4.

Label description: filter element—100, annular filter medium—1, assembly line—1a, center cavity—11, first end cover—2, opening—2a, oil return plug—21, positioning contour—22, bending section—22a, orientation part—22b, ring—23, stiffener—24, second end cover—3, filter—1000, filter assembly—200, oil return channel—200a, clean oil channel—200b, internal thread—200c, center pipe—201, coordination contour—201a, screw hole—201b, guide section—202, screw cover—300, external thread—300a.

The realization of the object, the functional features and the advantages of the present invention will be further explained with reference to the accompanying drawings in connection with the embodiments.

### DETAILED DESCRIPTION OF THE INVENTION

The technical solutions in the embodiments of the present application will be clearly and completely described below in conjunction with the drawings in the embodiments of the present application. obviously, the described embodiments are only a part of the embodiments, not all of the embodiments. All other embodiments obtained by those of ordinary skill in the art without creative work based on the embodiments in the present application fall within the scope of protection of the application.

For purposes of better describing and explaining embodiments of the present application, reference may be made to one or more of the accompanying drawings, but additional details or examples used to describe the drawings should not be construed to limit the scope of any of the inventions, presently described embodiments, or preferred modes of use herein.

In the description of the present invention, it should be noted that the terms “length”, “width”, “upper”, “lower”, ‘front “,’ rear”, left “, right”, top “, bottom”, inner “and outer” indicate the orientation or positional relationship based on the positional relationship shown in the drawings, which is only for convenience of description of the present invention, and does not indicate that the referred device must have a specific orientation or operate in a specific orientation, and thus is not to be construed as a limitation of the invention.

Unless defined otherwise, all technical and scientific terms used herein have the same meaning as commonly understood by one of ordinary skill in the art to which this application pertains. The terminology used herein in the specification is for the purpose of describing particular embodiments only and is not intended to be limiting of this application.

Generally, during the installation of the filter, the operator must accurately adjust the rotation position between the guide piece and the oil return plug when installing the annular filter element into the filter housing, which is prone to errors based on experience. In addition, due to the different structures of the filter element and the matched filter assembly in practical application, it is necessary to strictly control the positions of these parts during rotation to complete the assembly of the filter element and ensure that the positions are not deviated. Therefore, the processing of the filler element becomes complex.

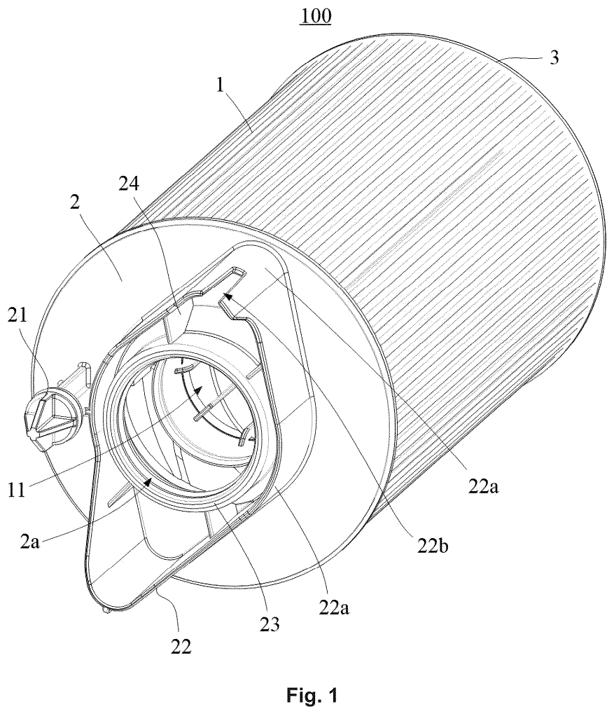

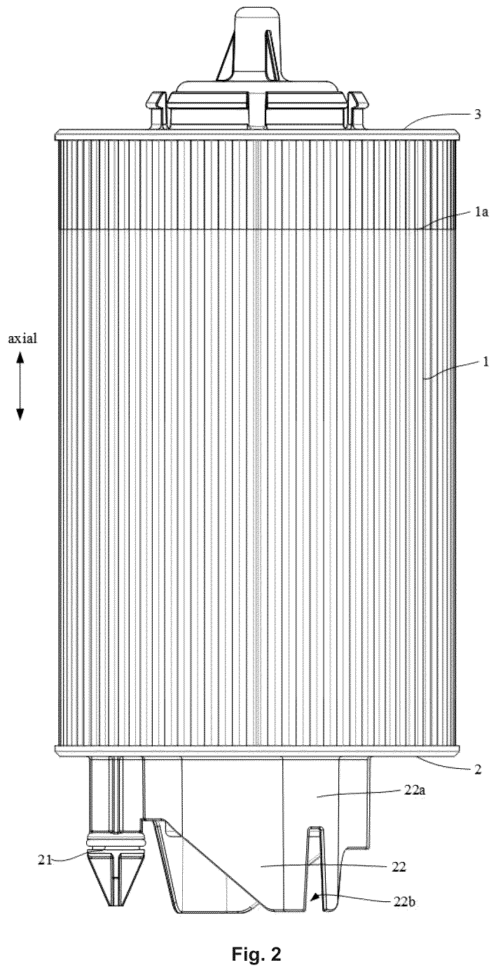

Referring to FIG. 1 and FIG. 2, a filter element 100 with positioning features includes an annular filter medium 1, and a first end cover 2 and a second end cover 3 connected to both ends of the annular filter medium 1.

Specifically, the annular filter medium 1 has a central cavity 11 defined around its central axis, and the outer side of the annular filter medium 1 forms a clean side and a non-clean side, respectively, wherein an oil return plug 21 is eccentrically provided on the end face of the first end cover 2, and the end face of the first end cover 2 also has an outwardly extending positioning contour 22 for coordination with an internal member (i.e., a coordination contour 201a) of the filter assembly 200, and after visual alignment in the axial direction, the filter element 100 is positioned or directly inserted, and allow the return oil return plug 21 to enter and close the oil return channel 200a inside the filter assembly 200. It should be noted that the oil return plug 21 is composed of a pin and a sealing ring. generally, the return plug extends along the axial direction, and this is also the case in this embodiment.

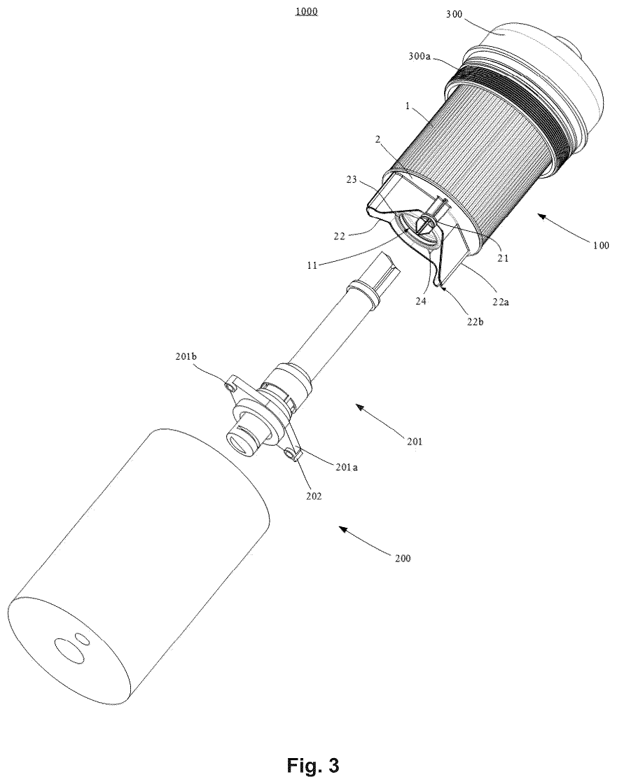

Referring to FIG. 3, an inner member of a filter assembly 200 has a coordination contour 201a, and in order to prevent the positioning contour 22 and the coordination contour 201a from being offset in the circumferential direction during positioning and coordination, and to keep the oil return plug 21 aligned with the inlet of the oil return channel 200a, the positioning contour 22 is provided with a plurality of bending section 22a. similarly, the coordination contour 201a is provided with bent portions corresponding to the bending section 22a, and the two are formed into a structure when being matched avoiding the movement of filter element 100 in its circumferential direction.

Generally, the filter assembly is the part of the filter housing, in which the oil outlet channel on the housing communicates with the clean side (i.e., the central cavity) of the filter element, and the oil return channel and the oil outlet channel are arranged at a distance. In order to prevent the internal components from being too complex and to prevent the addition of redundant structures, the coordination contour should be directly formed on the pipe fitting of the oil inlet channel, that is, the coordination contour and the positioning contour should be arranged around the central axis.

It should be noted here that the radial section of the positioning contour can be a square or other irregular shape with bending, and in this embodiment, a rhombus is selected, and the bending section is rounded to prevent the alignment condition from being too harsh. Because the positioning contour needs to allow the pipe fitting of the oil channel to pass through, the middle part of the positioning contour is hollow. Therefore, the radial section of the first end cover 2 of the positioning contour can be gradually increased or gradually contracted, or unchanged, and in this embodiment, the section is selected to be unchanged.

In this embodiment, the diamond-shaped positioning contour 22 is arranged around the central axis, and the oil return plug 21 and the positioning contour 22 are arranged at a distance from the first end cover 2. When the bending section 22a of the positioning contour 22 and the coordination contour 201a are positioned and interlocked, because it is not clear which side of the coordination contour 201a the oil return channel 200a is located on, there will be a 180.degree. reverse alignment, which should be stopped by an orientation structure to prevent the oil return plug from being damaged due to misassembly. We have set up an orientation part 22b, in the filter assembly 200, a guide portion 202 is set up corresponding to the coordination contour 201a. when the positioning contour 22 and the coordination contour 201a are positioned and matched, the first step is to insert the guide portion 202 into the orientation part 22b, and at this time, the oil return plug 21 is aligned with the return channel 200a; On the contrary, when the positioning contour 22 and the coordination contour are aligned 180 degrees in the opposite direction, the guide portion 202 will not enter the orientation part 22b, and the positioning and fitting process cannot be carried out. it should be understood that the orientation part and the guiding part are equivalent to a type of marking, which can guide the positioning contour 22 and the coordination contour 201a to be in the correct direction when aligned. their structures can be designed in other shapes, and in this embodiment, the positions of the guide portion 202 and the orientation part 22b can also be exchanged.

In the technical solution of the present invention, the first end cover 2 connected to one end of the annular filter medium 1 is provided with the positioning contour 22 extending outward, so that the operator can align by sight and then guide by the positioning contour 22 until the filter element 100 is positioned in the filter assembly 200. Meanwhile, the bending section limits the rotation position of the filter element, and the orientation section prevents the filter element from being installed 180 degrees reversely, so that the oil return plug 21 on the first end cover 2 can accurately close the oil return channel 200a in the filter assembly 200. The above solution can avoid using rotation to adjust the position of the oil return plug 21. At the same time, in the case where the filter element is not correctly positioned, the screw cover 300 and the filter assembly 200 cannot achieve threaded connection, which can effectively prevent oil pressure loss and damage to the parts due to incorrect assembly. Moreover, it can install the filter element 100 without too much operating experience, and the product processing is simple with low deviation requirements.

In order to simplify the structure of the positioning contour 22, please refer to FIG. 1 and FIG. 2. In an embodiment of the present invention, the positioning contour 22 is a wall extending axially outward from the end face of the first end cover 2, and the wall is a thin layer structure, which is continuous in the circumferential direction of the first end cover 2 to form a prism-like shape. Of course, the wall may not extend axially, and other shapes have been described above. Of course, the wall may not extend axially, as other shapes have been described earlier.

Correspondingly, the coordination contour 201a in the filter assembly 200 may also be an axially extending wall. It should be noted that the positioning contour 22 and the coordination contour 201a are not clamped with each other, but are close to and contact with each other, and only play a guiding role in the axial installation process of the filter element 100, so as to insert the oil return plug 21 into the oil return channel 200a. Based on the above axially matched positioning contour 22 and coordination contour 201a, the pin of the oil return plug 21 also extends axially on the end face of the first end cover 2, so that it can be inserted into the oil return channel 200a along the axial direction. Of course, it should be understood that the extension direction of the pin of the oil return plug 21 is consistent with the positioning contour 22, both extending axially.

Further, referring to FIG. 1, in an embodiment of the present invention, the wall forming the positioning contour 22 includes four bending sections 22a, so that the end face of the wall is approximately diamond-shaped. During the process of positioning and installing the filter element 100 on the filter assembly 200, the operator can align the coordination contour 201a of the filter assembly 200 with the bending sections 22a of the wall. Of course, the embodiments of the present invention are not limited to this, and the number of bending sections 22a of the wall can also be set to other numbers, and the end face of the wall can be made elliptical or other structures.

Since the outside of the filter element 100 is unfiltered oil and fills the bottom of the filter assembly 200, if the port of the positioning contour 22 is flat, it is easy to block the flow of oil at the bottom. Therefore, referring to FIG. 2, the outer edge of the wall extending axially outward along the end face of the first end cover includes high and low points, and the high and low points of the outer edge are smoothly transitioned so that the unfiltered oil can pass through the transition area on the positioning contour 22. Of course, the positioning wheel is directly formed. It should be understood that the outer edge of the lower part is still lower than the end position of the oil return plug 21, in order to positioning contour 22 before the oil return plug 21 touches the bottom of the filter assembly 200, preventing the oil return plug 21 from being damaged.

In addition, the smooth transition between the high position and the low position has other functions. When the operator does not visually align the positioning contour 22 and the coordination contour 201a, it is convenient to rotate the filter element 100, so that the contact part of the coordination contour 201a of the positioning contour 22 slides from the high position of the outer edge to the low position, and then the guide section 202 enters the orientation part 22b, and finally the positioning fit between the positioning contours 22 and the coordination contours 201a can be performed.

It should be noted that the wall forming the positioning contour 22 may be continuous or discontinuous along the circumferential direction of the first end cover 2, both of which can achieve positioning fit, and the discontinuous wall is also conducive to the channel of unfiltered oil. In this embodiment, in order to better achieve the positioning fit process, the wall is continuous, and the orientation part 22b does not cut off the wall.

Further, since the cross section of the wall is a symmetrical rhomboid, in order to prevent the inlet of the oil return channel 200a from not being seen clearly during alignment, which may lead to reverse assembly, please refer to FIG. 1 and FIG. 2, in an embodiment of the present invention, the positioning contour 22 has four bending sections 22a, which are arranged symmetrically in pairs, and the outer edges of two symmetrical bending sections 22a are lower than the other two. In this embodiment, the bayonet is positioning at one of the two curved sections with lower outer edges, such that during the process of positioning the filter element 100 in the filter assembly 200, the bayonet can first contact the card block and perform positioning and fitting. In addition, it should be noted that the bayonet and the card block both extend along the axial direction and are not interlocked. They only play a certain guiding role during the axial installation of filter element 100.

Of course, the embodiment of the present invention is not limited to this. In another embodiment, a block may be provided on the bending section 22a, and a bayonet may be provided on the inner member of the filter assembly 200.

Referring to FIG. 3, in one embodiment of the present invention, the wall is a continuous ring shape, and the inner circumferential surface of the annular wall and the outer circumferential surface of the coordination contour 201a are in close proximity and contact to achieve axial guidance, so that the filter element 100 is positioned within the filter assembly 200.

Of course, the embodiment of the present invention is not limited to this, and in another embodiment, the outer circumferential surface of the annular wall and the inner circumferential surface of the coordination contour realize axial guidance, depending on the internal structure of the filter assembly 200.

Further, the interference between the oil return plug 21 and the coordination contour 201a is not prevented when the filter element 100 is axially installed. Referring to FIG. 1, in one embodiment of the present invention, the oil return plug 21 is located on the outer side of the annular wall, and if the outer circumferential surface of the annular wall is in guiding fit with the inner circumferential surface of the coordination contour 201a, then the oil back plug 21 is located on the inner side of the annular walls.

Referring to FIG. 1, in an embodiment of the present invention, the center of the first end cover 2 is provided with an opening 2a into the central cavity 11, which is hermetically connected with the center pipe 201 in the filter assembly 200, so that the filtered clean oil can be pumped out. Based on the design of the opening 2a, the positioning contour 22 is arranged around the opening 2a, preferably symmetrically.

The opening 2a is internally provided with a sealing ring, and when the filter element is positioned and installed under the cooperation of the positioning contour 22 and the coordination contour 201a, the connection between the center pipe 201 and the sealing ring of the opening 2a gradually becomes tight. Please refer to FIG. 2, in order to indicate that the installation is completed, a circle of assembly line 1a is arranged on the periphery of the annular filter medium 1, and when the assembly line 1a is flush with the port of the filter assembly 200, it indicates that the filter is installed in place, and the operator can stop the installation.

In order to improve the strength of the wall forming the positioning contour 22, referring to FIG. 1, in an embodiment of the present invention, a ring 23 is formed extending outward along the axial direction of the opening 2a, and a stiffener 24 is connected between the outer periphery of the positioning contour 22 and the inner periphery of the ring 23 to enhance the stability of the positioning contour. Of course, the strength of the oil return plug 21 can also be improved by integrating the support pillar of oil the return plug 21 with the positioning contour 22, which also enhances the stability of the oil return plug 21.

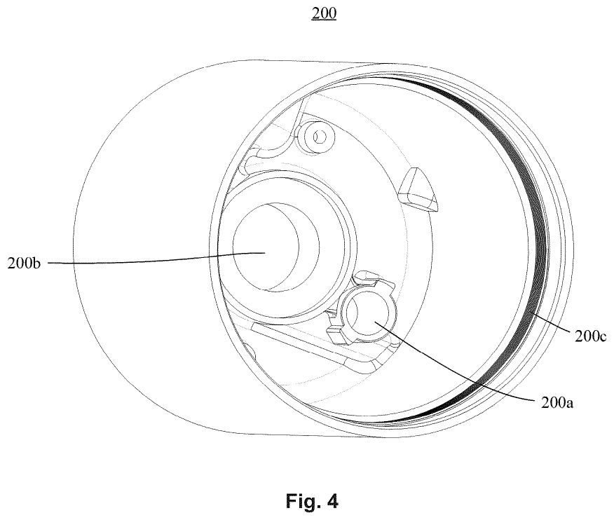

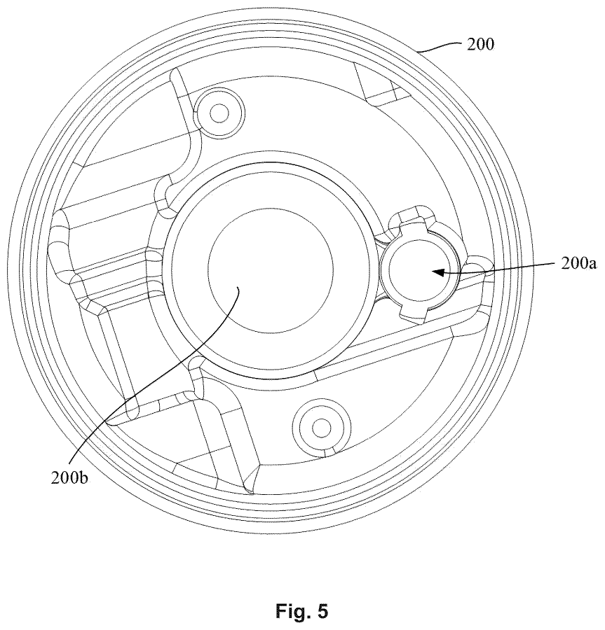

Referring to FIGS. 3-5, the filter 1000 includes the filter element 100 with the positioning feature and a filter assembly 200, the filter assembly 200 is provided with a coordination contour 201a matched with the positioning contour 22 and an oil return channel 200a connected to an oil tank.

Referring to FIG. 3, in an embodiment of the present invention, the filter assembly 200 has a center pipe 201 with one end connected to the center cavity 11, the bottom of the center pipe 201 forms a coordination contour 201a, and the coordination contour 201a is provided with a screw hole 201b, and the center pipe 201 is fixed in the filter assembly 200 by screws. The other end of the center pipe is connected to the clean oil channel 200b to pump the filtered clean oil.

Of course, the filter 1000 further includes a screw cover 300 for closing the filter assembly 200, and the filter assembly 200 and the screw cover 300 are respectively provided with an internal thread 200c and an external thread 300a for thread connection. In the process of installing the filter element 100, only when the assembly line 1a of the annular filter medium 1 is flush with the port of the filer assembly 200, the screw cover 300 and the filer assembly 200 can be completely thread connected, this design can prevent incorrect assembly and prevent oil pressure loss and damage to components caused by the unclosed oil return channel 200a due to the return plug 21.

The technical features of the above embodiments can be combined arbitrarily. For the sake of brevity, all possible combinations of the technical features of the above embodiments are not described. However, as long as there is no contradiction between the combinations of these technical features, they should be considered to be within the scope of this specification.

The above embodiments only represent several embodiments of the present application, and the description is more specific and detailed, but it should not be understood as limiting the scope of the patent for invention. It should be pointed out that, for those of ordinary skill in the art, several modifications and improvements can be made without departing from the concept of the present application, which all belong to the scope of protection of the application. Therefore, the scope of protection of this application shall be subject to the appended claims.

What is claimed is:

1. A filter element with positioning features, comprising:
an annular filter medium having a central cavity set about its central axis;
a first end cover and a second end cover connected to both ends of the annular filter medium;
wherein the end face of the first end cover is eccentrically provided with an oil return plug, and is provided with a positioning contour extending outward for coordination with an internal component of the filter assembly, so that the oil return plug enters and closes an oil return channel when a filter element is assembled into the filter assembly;
the positioning contour comprises at least one bending section, so that the filter element is positioned in the filter assembly, one of the bending sections of the positioning contour is provided with an orientation part for positioning and cooperating with the guide section inside the filter assembly.

2. The filter element with positioning features according to claim 1, wherein the positioning contour is a wall extending axially outward from the end face of the first end cover.

3. The filter element with positioning features according to claim 2, wherein the outer edge of the wall extending axially outward along the end face of the first end cover comprises at least one high point and at least one low point, and the transition between the high point and the low point of the outer edge is smooth.

4. The filter element with positioning features according to claim 2, wherein the wall is arranged continuously or discontinuously along the circumference of the first end cover.

5. The filter element with positioning features according to claim 4, wherein the wall is continuously arranged along the circumference of the first end cover, and the inner circumferential surface of the continuous wall is positioned and matched with the outer circumferential surface of the inner member of the filter assembly.

6. The filter element with positioning features according to claim 5, wherein the oil return plug is located on the outside of the continuous wall.

7. The filter element with positioning features according to claim 2, wherein the wall is continuously arranged along the circumference of the first end cover, and the inner circumferential surface of the continuous wall is positioned and matched with the outer circumferential surface of the inner member of the filter assembly.

8. The filter element with positioning features according to claim 7, wherein the oil return plug is located on the outside of the continuous wall.

9. The filter element with positioning features according to claim 1, wherein the first end cover is centrally provided with an opening into the central cavity, and the positioning contour is arranged around the opening.

10. The filter element with positioning features according to claim 9, wherein a ring is formed extending axially outward along the opening, and a stiffener is connected between the positioning contour and the ring.

11. A filter comprising:
the filter element with positioning features as claimed in claim 1;
a filter assembly provided with an oil return channel and a coordination contour cooperating with the positioning contour.

12. The filter according to claim 11, wherein said filter assembly is provided with a center pipe communicating with said central cavity, said coordination contour being formed in center pipe.
